(19) United States
(12) Patent Application Publication
(10) Pub. No.: US 2026/0340240 A1
(43) Pub. Date: Oct. 29, 2026

(54) METHOD FOR RAPID MODELING AND SIMULATION OF FLOW NETWORK FOR SUPERCRITICAL CARBON DIOXIDE BRAYTON CYCLE

(71) Applicant: Harbin Engineering University, Harbin City (CN)

(72) Inventors: Yuandong ZHANG, Harbin City (CN); Genglei Xia, Harbin City (CN); Chenyang Wang, Harbin City (CN); Jilin Sun, Harbin City (CN); Bowen Zhang, Harbin City (CN); Yifan Xu, Harbin City (CN)

(21) Appl. No.: 19/642,722

(22) Filed: Apr. 9, 2026

(30) Foreign Application Priority Data
Apr. 17, 2025 (CN) 202510482710.0

(51) Int. Cl. G06F 30/28

(52) U.S. Cl. CPC G06F 30/28

(57) ABSTRACT

A method for rapid modeling and simulation of a flow network for a supercritical carbon dioxide Brayton cycle is provided, including: constructing an input card and reading parameters of a flow network system; performing node division on the flow network system based on the equipment node division part of the input card, and generating a connection relation matrix; constructing a pressure matrix and an enthalpy matrix of the flow network based on the three conservation equations and the calculation result of the previous time step; solving the pressure matrix and the enthalpy matrix through a parallel algorithm; outputting the operating parameters in real time by synchronizing calculation with physical time in a real-time simulation mode, and transmitting at least one of the operating parameters to a control-system interface for adjustment in the valve, the compressor, and the turbine.

### CROSS-REFERENCE TO RELATED APPLICATIONS

This application claims priority to Chinese Patent Application No. 202510482710.0, filed on Apr. 17, 2025, the contents of which are hereby incorporated by reference.

### TECHNICAL FIELD

The disclosure belongs to the technical field of real-time simulation of nuclear power plants, and in particular to a method for rapid modeling and simulation of a flow network for a supercritical carbon dioxide Brayton cycle.

### BACKGROUND

A supercritical carbon dioxide Brayton cycle system is a nuclear power plant loop system based on supercritical carbon dioxide. The system utilizes the unique properties such as high density and low viscosity of carbon dioxide under supercritical conditions, and may achieve higher energy conversion efficiency and smaller equipment size. At present, there have been multiple schemes for the layout of the supercritical carbon dioxide Brayton cycle, and its simulation research mainly focuses on the exploration and comparison of cycle characteristics, efficiency and control strategies. In the field of simulation, traditional water reactors usually adopt a method combining experiments and calculations, and draw conclusions by analyzing operating characteristics and investigate the underlying mechanisms of system behavior, so as to optimize the system design and operating strategy.

However, the supercritical carbon dioxide Brayton cycle system operates at a high pressure, and the development of related equipment is not yet mature, leading to relatively few experimental studies. Therefore, most of the current research relies on simulation methods. When facing different service environments or proposing new cycle parameters, technicians need to repeatedly develop simulation software specially for specific cycle layouts, which is an inefficient and time-consuming process. In addition, the existing simulation methods lack flexibility and universality, and may not quickly adapt to the diversified cycle design requirements. Therefore, there is a need for a method capable of efficient and flexible modeling and simulation of a supercritical carbon dioxide Brayton-cycle flow network, while supporting synchronization of simulated operating parameters with a control-system interface for adjustment of the valves, compressors, and turbines in the flow network system.

### SUMMARY

To solve the above technical problems, the disclosure proposes a method for rapid modeling and simulation of a flow network for a supercritical carbon dioxide Brayton cycle, so as to solve the problems existing in the prior art.

To achieve the above objective, in a first aspect, the disclosure provides a method for rapid modeling and simulation of a flow network for a supercritical carbon dioxide Brayton cycle, including:
constructing an input card and reading parameters of a flow network system;
performing node division on the flow network system based on an equipment node division part of the input card, including node division of a turbine by two nodes and one flow line such that a first turbine node provides input parameters, a second turbine node has a volume corresponding to a turbine volume to reflect a volume-inertia phenomenon of the turbine during operation, and a middle turbine flow line reflects a pressure drop of the turbine; node division of a compressor by two nodes and one flow line such that a first compressor node provides input parameters, a second compressor node has a volume corresponding to a compressor volume to reflect a volume-inertia phenomenon of the compressor during operation, and a middle compressor flow line reflects a pressure head of the compressor; subjecting heat components of a heat exchanger to node division and calculation in a two-node manner, and generating a connection relation matrix;
constructing a pressure matrix and an enthalpy matrix of the flow network based on three conservation equations and a calculation result of a previous time step;
solving the pressure matrix and the enthalpy matrix through a parallel algorithm to obtain operating parameters of the flow network; and
outputting the operating parameters in real time by synchronizing calculation with a real-time simulation mode, and transmitting at least one of the operating parameters to a control-system interface for adjustment in the valve, the compressor, and the turbine in the flow network system.

In an embodiment, a step of constructing an input card includes:
designing a specific input card format allowing a user to input various parameters of the flow network system, including node sizes, pipeline connection relations, fluid physical property parameters, flow data, and external energy and momentum input; and
providing the input card in a form of a text file, with a method automatically reading and parsing input data;
where types of equipment available for input in the input card include a reactor, a turbine, a compressor, a heat exchanger, a valve, a pipeline, a temperature boundary, a pressure boundary, a flow boundary, a power boundary, and a single node.

In an embodiment, a step of performing node division on the flow network system includes:
dividing models of the turbine and the compressor into two nodes plus one flow line, performing longitudinal node division on model of the heat exchanger in a multi-section manner, and adopting two heat component nodes for each longitudinal node; and
assigning an identification number to each node, storing identification numbers in flow lines, and generating the connection relation matrix with the identification numbers as coordinates and positions of the nodes in a node matrix as values to facilitate connection relation identification in subsequent flow network calculation.

In an embodiment, a pressure drop of the turbine is calculated by a Stodola ellipse method.

In an embodiment, relationships among a flow rate, a rotation speed and a pressure ratio of the compressor are obtained through characteristic curve calculation.

In an embodiment, heat components of the heat exchanger are subjected to the node division and calculation in a two-node manner, and a two-dimensional matrix is constructed and solved for energy equations of two heat component nodes.

In an embodiment, a step of constructing the pressure matrix and the enthalpy matrix of the flow network includes:
calculating equipment parameters, linear terms and constant terms of an energy equation, and linear terms and constant terms of mass equation; and
gradually calculating a pressure change and an enthalpy change of each node in the flow network at a next time step through a semi-implicit difference format of a momentum equation.

In an embodiment, the parallel algorithm solves the matrix by a Gaussian elimination method with pivot selection, and steps include:
performing the pivot selection on a target matrix;
performing LU decomposition on the target matrix, and first calculating a first row of a U matrix and a first column of an L matrix in parallel;
calculating rows of the U matrix and columns of the L matrix corresponding to diagonal elements in parallel; and
calculating intermediate quantities of result variables, and finally calculating results.

In an embodiment, a step of outputting the calculation results in real time includes:
outputting calculation results in real time in a txt file format, and recording pressure, temperatures, flow rates and equipment parameters of the flow network system; and
outputting calculation results of total duration in a csv file format, and recording system state changes during an entire simulation process.

In an embodiment, a step of realizing the simulations at the different speeds by setting the super-real-time factor includes:
setting the super-real-time factor in the input card by a user, and accelerating a simulation process by a method according to a set multiple; and
synchronizing calculation with time of physical reality in a real-time simulation mode; and accelerating a calculation process by the method through increasing multiples in a super real-time simulation mode.

Compared with the prior art, the disclosure has the following advantages and technical effects.

The disclosure provides a method for rapid modeling and simulation of a flow network for a supercritical carbon dioxide Brayton cycle, which first constructs an input card and reads parameters of a flow network system; then performs node division on the flow network system based on the equipment node division part of the input card, and generates a connection relation matrix; next constructs a pressure matrix and an enthalpy matrix of the flow network based on the three conservation equations and the calculation result of the previous time step; then solves the pressure matrix and the enthalpy matrix through a parallel algorithm; and finally outputs the operating parameters in real time by synchronizing calculation with physical time in a real-time simulation mode, and transmitting at least one of the operating parameters to a control-system interface for adjustment in the valves, compressors, and turbines in the flow network system.

The disclosure may carry out various layout and parameter settings, and the carbon dioxide Brayton cycle flow network method capable of modeling through different equipment combinations may improve the modeling efficiency; and may perform real-time and super real-time simulations to achieve the design and teaching purposes.

### BRIEF DESCRIPTION OF THE DRAWINGS

The accompanying drawings, which form a part of the disclosure, are used to provide a further understanding of the disclosure, and the schematic embodiments of the disclosure and their descriptions are used to explain the disclosure, and do not constitute an improper limitation of the disclosure. In the accompanying drawings:

FIG. 1 is a diagram of method structure division according to an embodiment of the disclosure.

FIG. 2 is a calculation flow chart adopting a semi-implicit difference method according to an embodiment of the disclosure.

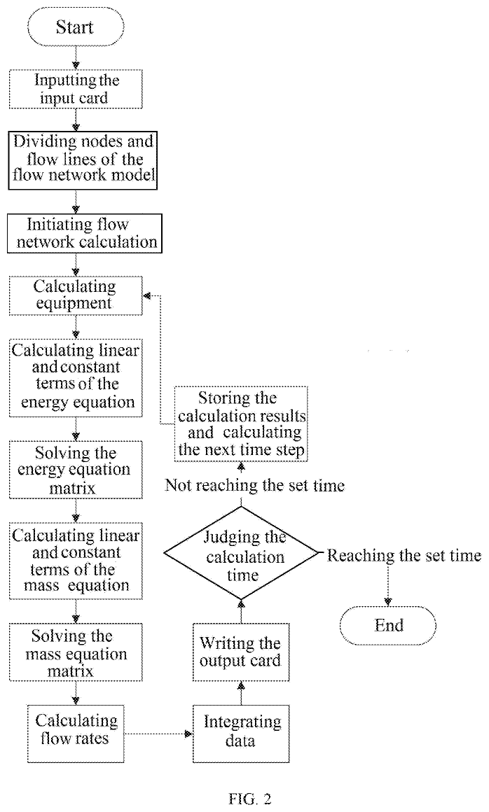

FIG. 3 is a schematic diagram of a turbine node model according to an embodiment of the disclosure.

FIG. 4 is a schematic diagram of a compressor node model according to an embodiment of the disclosure.

### DETAILED DESCRIPTION OF THE EMBODIMENTS

It may be noted that the embodiments in the disclosure and the features in the embodiments may be combined with each other without conflict. The disclosure will be described in detail below with reference to the accompanying drawings and in combination with the embodiments.

It may be noted that the steps shown in the flow charts of the accompanying drawings may be executed in a computer system such as a set of computer executable instructions, and although a logical order is shown in the flow charts, in some cases, the steps shown or described may be executed in an order different from that herein.

### Embodiment 1

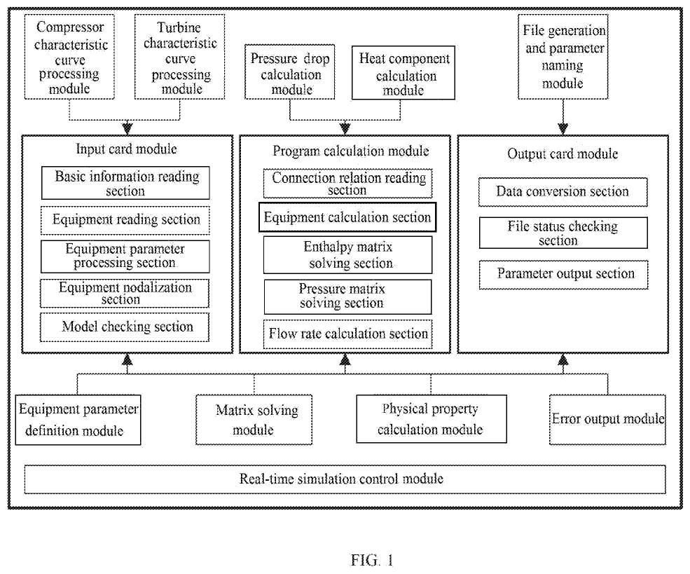

As shown in FIG. 1, the embodiment provides a method for rapid modeling and simulation of a flow network for a supercritical carbon dioxide Brayton cycle, including the following steps.

Step 1: constructing an input card and reading parameters of a flow network system;

In an embodiment, the step of constructing an input card includes:
designing a specific input card format allowing a user to input various parameters of the flow network system, including node sizes, pipeline connection relations, fluid physical property parameters, flow data, and external energy and momentum input; and
providing the input card in a form of a text file, with a method automatically reading and parsing input data.

Specifically, the supercritical carbon dioxide Brayton cycle system is analyzed and an input card is compiled. The types of equipment available for input in the input card include a reactor, a turbine, a compressor, a heat exchanger, a valve, a pipeline, a temperature boundary, a pressure boundary, a flow boundary, a power boundary, and a single node. Among them, the identification number of the reactor is “hprt”, the turbine is “turb”, the compressor is “comp”, the heat exchanger is “htch”, the valve is “valv”, the flow boundary is “flbd”, the pressure boundary is “prbd”, the power boundary is “pwbd”, the temperature boundary is “tmbd”, the single node is “sgnd”, and the pipeline is “pipe”. The input card uses “end” as the end identifier.

In an embodiment, characteristic curve parameter files of the turbine and the compressor are provided, the compiling format of the turbine characteristic curve file is flow rate (kilogram/second), pressure ratio, rotation speed (revolution/minute), efficiency (percent); the file format of the compressor characteristic curve file is flow rate (kilogram/second), pressure ratio, efficiency (percent).

The method is started, and the basic information reading part and the equipment reading part in the input card module read the parameters of the flow network system. These parameters include the size of each node of the flow network system, pipeline connection relationships, fluid physical property parameters, flow data, and external energy and momentum input. The equipment parameter processing part of the method parses and processes the input data to provide a basis for the subsequent calculation process.

Step 2: performing node division on the flow network system based on an equipment node division part of the input card, and generating a connection relation matrix;

In an embodiment, the step of performing the node division on the flow network system includes:
dividing models of the turbine and the compressor into two nodes plus one flow line, performing longitudinal node division on model of the heat exchanger in a multi-section manner, and adopting two heat component nodes (heating end and cold end flow channel nodes) for each longitudinal node; and
assigning an identification number to each node, storing identification numbers in flow lines, and generating the connection relation matrix with the identification numbers as coordinates and positions of the nodes in a node matrix as values to facilitate connection relation identification in subsequent flow network calculation.

Specifically, the equipment node division part in the input card module automatically performs node division on the flow network system and generates a connection relation matrix. It includes automatically performing node division on the flow network system according to the input parameter information. The method judges the positions of each node in the flow network and their mutual connection relations according to the input card. According to the connection mode of the nodes, the method may automatically generate a connection relation matrix for solving the subsequent flow network system.

In an embodiment, the connection relation matrix is read by the method calculation module and the connection relation of the flow network is identified, and its specific format is as follows: the position of each node in the flow network is marked as a unique identification number for characterizing the information of the node (the specific composition is equipment identification number+equipment quantity number+node number in the equipment). The identification number of each node is used as the coordinate of the matrix and stored in the flow line. The value of the matrix under the corresponding coordinate is the position of the node in the pressure matrix and the enthalpy matrix.

If there is a format error in the input card, such as duplicate equipment names, pipelines not connected to equipment, etc., the model checking part of the method may generate an error prompt.

The input card transmits the node, flow line, equipment and connection relation information to the method calculation module, which first reads the connection relation and generates retrieval variables of nodes and flow lines to facilitate subsequent calculation.

In an embodiment, the node retrieval variable directly stores the position of the flow line in the pressure matrix, and is used for extracting the inlet flow line flow rate in the case of single flow line connection inside the equipment; the flow line retrieval variable stores the identification number of the node, and is used for the flow line to extract the inlet and outlet node parameters.

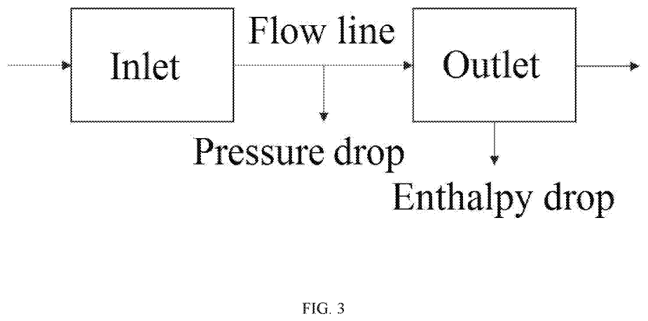

The method reads equipment parameters such as turbine pressure drop and heat exchange capacity of the heat exchanger, and processes them into the heat exchange capacity of nodes, and the pressure head and admittance of flow lines. For the turbine, compressor, heat exchanger and valve models, the input and output of the module and the processing flow are as follows:
(a) The turbine is modeled by two nodes and one flow line as shown in FIG. 3, where the first node only provides input parameters, the volume of the second node is the volume of the turbine to reflect the volume inertia phenomenon and output power of the turbine during operation, and the middle flow line is used to reflect the pressure drop of the turbine. In the turbine module, the input includes structural parameters of the turbine, inlet flow rate, and fluid physical property parameters of the inlet and outlet, and the output is the pressure drop and energy loss of the turbine.

The pressure drop of the turbine is calculated by the Stodola ellipse method, and the calculation formula is:

$$\frac{{φ}_{d}}{{φ}_{od}} = \frac{\sqrt{1 - {( \frac{{P}_{out , d}}{{P}_{in , d}} )}^{2}}}{\sqrt{1 - {( \frac{{P}_{out , d}}{{P}_{in , d}} )}^{2}}} ; \qquad ( 1 )$$

In the formula, the subscript in denotes the turbine inlet, out denotes the turbine outlet, d denotes the design value, and od denotes the off-design value. The calculation formula of q is as follows:

$$φ = F \frac{\sqrt{t}}{p} ; \qquad ( 2 )$$

In the formula, F is the flow rate in kilogram/second; t is the node temperature in Kelvin; and p is the node pressure in Pascal.

The calculation formula of the energy loss of the turbine model is as follows:

$${W}_{shaft} = ( {h}_{in} - {h}_{out} ) F = [ ( {h}_{in} + \frac{1}{2} {υ}_{in}^{2} - {h}_{out , j , s} ) η - \frac{1}{2} {υ}_{in}^{2} + \frac{1}{2} {υ}_{out}^{2} ] F ; \qquad ( 3 )$$

In the formula, Vin and Vout are the velocities at the inlet and outlet of the node; h_{out,j,s} is the isentropic stagnation outlet enthalpy, which is obtained by querying the physical property function:

h_{out,j,s}=f(P_{out,j},s_{in,j}) (4);

The stagnation entropy sⱼ is obtained by querying the physical property function, and the stagnation pressure Pⱼ is obtained by the following formula:

$${P}_{j} = P {( 1 + \frac{γ - 1}{γ} \frac{{ρυ}^{2}}{2 P} )}^{\frac{γ}{γ - 1}} ; \qquad ( 5 )$$

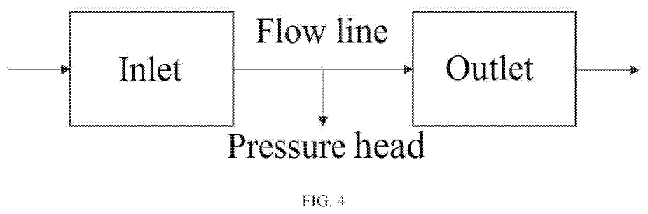

In the formula, γ is the specific heat ratio of the working medium; and υ is the velocity.
(b) In an embodiment, the compressor is modeled by two nodes and one flow line as shown in FIG. 4. Among them, the first node only provides input parameters, the volume of the second node is the volume of the compressor to reflect the volume inertia phenomenon of the compressor during operation, and the middle flow line is used to reflect the pressure head of the compressor. In the compressor module, the input includes structural parameters of the compressor, inlet flow rate, and fluid physical property parameters of the inlet and outlet, and the output is the pressure rise of the compressor.

The relational expression among the flow rate, rotation speed and pressure ratio of the compressor model is as follows:

$${( \frac{{P}_{out}}{{P}_{i n}} )}^{2} = a {F}^{2} + b ( \frac{n}{{n}_{d}} ) \cdot F + c {( \frac{n}{{n}_{d}} )}^{2} ; \qquad ( 6 )$$

In the formula, a, b and c are experimental coefficients which are obtained through characteristic curve calculation; and n_{d} is the design rotation speed.

The lift of the compressor is:

$${P}_{pump} = ( 1 - 1 / \sqrt{a {F}^{2} + b F + c} ) {P}_{out} ; \qquad ( 7 )$$

The relationship between efficiency and flow rate is:

η=a+bF+cF² (8);
(c) In an embodiment, the heat components of the heat exchanger are subjected to node division and calculation in a two-node manner. The input of the heat exchanger module includes structural parameters of the heat exchanger and fluid physical property parameters of heat exchanger nodes, and the output is the heat exchange capacity of the heat exchanger. The heat balance equations of the two nodes are respectively:

$$\frac{A {λ}_{s}}{x} ( {t}_{w 1} - {t}_{w2} ) + {Ah}_{h} ( {t}_{w 1} - {t}_{hfi} ) = 0 ; \qquad ( 9 )$$

$$\frac{A {λ}_{s}}{x} ( {t}_{w 1} - {t}_{w2} ) - {Ah}_{h} ( {t}_{w 2} - {t}_{cfi} ) = 0 ; \qquad ( 10 )$$

In the formula, A is the node heat exchange area in square meter; λₛ is the node thermal conductivity in watt/(meter Kelvin); x is the node length in meter; t_{w1} and t_{w2} are the temperatures of the left and right nodes in Kelvin; t_{hfi} and t_{cfi} are the temperatures of the hot end and cold end fluids in Kelvin; hₕ and h_{c} are the heat transfer coefficients of the hot end and cold end fluids in watt/(square meter·Kelvin).

Therefore, a matrix is as follows:

$$[ \begin{matrix}\frac{A {λ}_{s}}{x} + {Ah}_{h} & \frac{A {λ}_{s}}{x} \\ \frac{A {λ}_{s}}{x} & - \frac{A {λ}_{s}}{x} - {Ah}_{c}\end{matrix} ] [ \begin{matrix}{t}_{w 1} \\ {t}_{w 2}\end{matrix} ] = [ \begin{matrix}{Ah}_{h} {t}_{hfi} \\ - {Ah}_{h} {t}_{cfi}\end{matrix} ] ; \qquad ( 11 )$$

Solving the matrix may obtain the boundary temperature, and then the heat exchange capacity is calculated.

The convective heat transfer model adopts the Gnielinski heat transfer model, and the calculation formula is as follows:

$$\{ \begin{matrix}u = \frac{( \frac{{f}_{c}}{8} ) ( Re - 1000 ) Pr [ 1 + {( \frac{d}{l} )}^{\frac{2}{s}} ] {( \frac{{t}_{l}}{{t}_{w}} )}^{0.45}}{1 + 12.7 \sqrt{\frac{{f}_{c}}{8}} ( {Pr}^{\frac{3}{s}} - 1 )} \\ \begin{matrix}Nu = 4.089 + \frac{{Re}_{C} - 4.089}{5000 - 2300} ( Re - 2300 ) , 2300 < Re \leq 5000 \\ Nu = 4.089 , Re \leq 2300\end{matrix}\end{matrix} ; \qquad ( 12 )$$

In the formula, Nu is the Nusselt number; Pr is the Prandtl number; d is the hydraulic diameter of the flow channel in meter; l is the length of the pipe section in meter; tr is the fluid temperature in Kelvin; t_{w} is the wall temperature in Kelvin; and f_{c} is the Darcy-Weisbach friction coefficient.
(d) The valve model is calculated by adopting a critical flow model, and first judges whether the valve is in critical flow. The judgment is carried out by calculating the critical admittance. The calculation formula of the critical admittance is:

$$C = \frac{{V}_{cr} A}{{p}_{in} - {P}_{out}} ; \qquad ( 13 )$$

In the formula, Ver is the sonic velocity; A is the cross-sectional area at the narrowest part of the valve; Pin is the inlet pressure of the valve; Pₒᵤₜ is the outlet pressure of the valve.

When the critical admittance is less than the flow line admittance, it indicates that critical flow has occurred at the valve, and the admittance of the flow line adopts the critical admittance, otherwise the normal admittance is adopted.

Step 3: constructing a pressure matrix and an enthalpy matrix of the flow network based on three conservation equations and a calculation result of a previous time step;
the specific forms of solving the three conservation equations of the flow network are as follows:
(a) The expression of the momentum equation is:

$$\frac{{dF}_{i}}{d τ} = A ( - \frac{{dP}_{i}}{dz} + {δ}_{s , i} \frac{{dP}_{s , i}}{dz} - \frac{{dP}_{f , i}}{dz} - \frac{{dP}_{s , i}}{dz} - {ρ}_{i} g \frac{dH}{dz} ) ; \qquad ( 14 )$$

In the formula, Fᵢ is the fluid flow rate of the flow line in kilogram/second; A is the cross-sectional area of the flow channel in square meter; Pᵢ is the pressure drop in Pascal; δ_{s,i} is an identification factor, equal to 0 or 1; P_{s,i} (first instance) is the pressure head term in Pascal; P_{f,i} is the frictional resistance along the path in Pascal; P_{s,i} (second instance) is the local resistance in Pascal; and

$${ρ}_{i} g \frac{dH}{dz}$$

is the gravity term.

After integration, the following is obtained:

$${L}_{i} \frac{{dF}_{i}}{d τ} = A [ ( {P}_{j} - {P}_{i} ) + {P}_{s , i} - {P}_{f , i} - {P}_{s , i} - {ρ}_{i} gH ] ; \qquad ( 15 )$$

where the frictional resistance along the path P_{f,i} may be expressed by the Darcy formula:

$${P}_{f , i} = \frac{{λ}_{i} {L}_{i} {F}_{i}^{2}}{2 {ρ}_{i} {d}_{i} {A}^{2}} = {f}_{i} {F}_{i}^{2} ; \qquad ( 16 )$$

In the formula, λᵢ is the frictional resistance coefficient along the path; Lᵢ is the node length in meter; ρᵢ is the fluid density in kilogram/cubic meter; dᵢ is the node diameter in meter;

$${f}_{i} = \frac{{λ}_{i} {L}_{i}}{2 {ρ}_{i} {d}_{i} {A}^{2}} .$$

The frictional resistance coefficient along the path may be calculated according to the Nikuradse experimental chart. The method adopts the Zigrang-Sylvester resistance model.

The local resistance is defined by the following formula:

$${P}_{s , i} = \frac{ξ {F}_{i}^{2}}{2 {ρ}_{i} {A}^{2}} ; \qquad ( 17 )$$

In the formula, ξ is the local resistance coefficient obtained through experiments. Generally, 0.5 is taken at the inlet of the heat exchanger and 1 at the outlet.

In summary, the total resistance and resistance coefficient are expressed by the following formula:

$${P}_{all , i} = \frac{{λ}_{i} {L}_{i} {F}_{i}^{2}}{2 {ρ}_{i} {d}_{i} {A}^{2}} + \frac{ξ {F}_{i}^{2}}{2 {ρ}_{i} {A}^{2}} ; \qquad ( 18 )$$

Assuming that the time variation term is 0, semi-implicit difference processing is performed to obtain:

$${F}_{i}^{n} = \frac{{P}_{j} - {P}_{i} + {P}_{s , i} - {ρ}_{i} gH}{\sqrt{{ζ}_{i} ( {P}_{j}^{0} - {P}_{i}^{0} + {P}_{s , i} - {ρ}_{i} gH )}} \qquad ( 19 )$$

$${ζ}_{i} = \frac{1}{2 {ρ}_{i} {A}^{2}} ( \frac{{λ}_{i} {L}_{i}}{{d}_{i}} + ξ ) ;$$

$$In the formula ,$$

(b) The expression of the energy conservation equation is:

$$\frac{d ( {M}_{i} {h}_{i} )}{d τ} = \sum {h}_{j} {F}_{i j} - \sum {h}_{j} {F}_{i k} + {Q}_{f} - {W}_{shaft} ; \qquad ( 20 )$$

In the formula, Mi is the node mass in kilogram; hᵢ is the average specific enthalpy of the node in kilojoule/kilogram; h_{i,in} and h_{i,out} are the specific enthalpy of the inflow and outflow of the node in kilojoule/kilogram respectively; F_{i,in} and F_{i,out} are the mass flow rate of the inflow and outflow of the node in kilogram/second respectively; Q_{f} is the heat transfer amount of the node in watt; and W_{shaft} is the external work done by the node in watt.
(c) The expression of the mass conservation equation is:

$${V}_{i} \frac{d {ρ}_{i}}{d τ} = \sum {F}_{i , i n} - \sum {F}_{i , out} ; \qquad ( 21 )$$

In the formula, Vᵢ is the node volume in cubic meter; ρᵢ is the fluid density of the node in kilogram/cubic meter; and F_{i,in} and F_{i,out} are the flow rate of the inflow and outflow of the node in kilogram/second respectively.

The pressure matrix and the enthalpy matrix are constructed based on the three conservation equations and the calculation result of the previous time step.

Step 4: solving the pressure matrix and the enthalpy matrix through a parallel algorithm;

In an embodiment, the pressure matrix and the enthalpy matrix are solved through a parallel algorithm. It includes adopting a parallel calculation algorithm, and through a multi-thread distributed calculation mode, and the method may process multiple calculation tasks at the same time, significantly reducing the time for matrix solution, so as to meet the calculation speed requirements of real-time and super real-time simulation.

Assuming there is a system of linear equations Ax=b, the parallel algorithm method is as follows:
(a) performing the pivot selection on a target matrix A;
(b) performing LU decomposition on the target matrix A, and first calculating a first row of a U matrix and a first column of an L matrix in parallel, with the calculation formulas being:

$${l}_{i 1} = \frac{{a}_{i 1}}{{a}_{l 1}} , i = 2 , 3 , … , n$$

u₁ᵢ=a₁ᵢ, i=2, 3, . . . , n and respectively;
(c) calculating the diagonal elements of the U matrix:

$${u}_{r r} = {a}_{r r} - {\sum }_{k = 1}^{r - 1} {l}_{r k} {u}_{k r} ;$$

(d) calculating rows of the U matrix and columns of the L matrix corresponding to the diagonal elements in parallel, with the calculation formulas being:

$${u}_{ri} = {a}_{r i} - {\sum }_{k = 1}^{r - 1} {l}_{rk} {u}_{ki} , i = r , r + 1 , … , n ; and$$

$${l}_{i r} = ( {a}_{ir} - {\sum }_{k = 1}^{r - 1} {l}_{i k} {u}_{k r} ) / {u}_{rr} , i = r + 1 , … , n ;$$

(e) calculating intermediate quantities of result variables, assuming Ly=b, the calculation formula is:

$${y}_{1} = {b}_{1} , {y}_{i} = {b}_{i} - {\sum }_{k = 1}^{i - 1} {l}_{ik} {y}_{k} , i = 2 , 3 , … , n ;$$

(f) calculating the result x, the calculation formula is:

$${x}_{n} = {y}_{n} / {u}_{n n} , {x}_{i} = {y}_{i} - {\sum }_{k = i + 1}^{n} {u}_{ik} {x}_{k} / {u}_{i i} , i = n - 1 , n - 2 , … , 1.$$

The calculated node, flow line and equipment data are transmitted to the output card module, which reads the node and flow line parameters in sequence and processes them into output parameters.

Step 5: outputting calculation results in real time, and realizing simulations at different speeds by setting a super-real-time factor.

In an embodiment, a step of outputting the calculation results in real time includes:
outputting calculation results in real time in a txt file format, and recording pressure, temperatures, flow rates and equipment parameters of the flow network system; and
outputting calculation results of total duration in a csv file format, and recording system state changes during an entire simulation process.

Specifically, the calculation results are output in real time in a txt file format, including outputting the calculation results after an output time step in a txt file format. The file records the parameter changes of the system, including the pressure, temperature, flow rate and equipment parameters of the system. The user may read and view the text file in read-only mode to know the operating state of the flow network system in real time.

The file state checking part checks whether the csv file exists, if not, creates a new file and writes the header; if it exists, outputs the parameters in a new line. The calculation results of the total duration are output in a csv file format, including outputting all system change processes during the simulation process in a csv file format. This file records the start and end time of the entire simulation process and the system state corresponding to the time of each step in detail, helping the user draw a system parameter change chart.

Real-time and super real-time simulations are realized by setting a super-real-time factor, and the real-time simulation control module allows the user to set a super-real-time factor (such as 1 time, 10 times, 100 times, etc.) in the input card to control the simulation speed. Through the setting, the system may accelerate the simulation process as required. In the real-time simulation mode, the calculation is synchronized with the time of physical reality; in the super real-time simulation mode, the system accelerates the calculation process by increasing the multiple.

The above are only the optional specific implementation modes of the disclosure, but the protection scope of the disclosure is not limited thereto. Any change or replacement that may be easily thought of by those skilled in the art within the technical scope disclosed by the disclosure shall be covered within the protection scope of the disclosure. Therefore, the protection scope of the disclosure shall be subject to the protection scope of the claims.

What is claimed is:

1. A method for modeling and simulation of a flow network for a supercritical carbon dioxide Brayton cycle, comprising:
constructing an input card and reading parameters of a flow network system;
performing node division on the flow network system based on an equipment node division part of the input card, comprising node division of a turbine by two nodes and one flow line such that a first turbine node provides input parameters, a second turbine node has a volume corresponding to a turbine volume to reflect a volume-inertia phenomenon of the turbine during operation, and a middle turbine flow line reflects a pressure drop of the turbine; node division of a compressor by the two nodes and the one flow line such that a first compressor node provides second input parameters, a second compressor node has a volume corresponding to a compressor volume to reflect a volume-inertia phenomenon of the compressor during operation, and a middle compressor flow line reflects a pressure head of the compressor; subjecting heat components of a heat exchanger to node division and calculation in a two-node manner, and generating a connection relation matrix;
calculating linear terms and constant terms of conservation equations based on the connection relation matrix and equipment parameters;
constructing a pressure matrix and an enthalpy matrix of the flow network based on three conservation equations and a calculation result of a previous time step;
solving the pressure matrix and the enthalpy matrix through a parallel algorithm to obtain operating parameters of the flow network; and
outputting the operating parameters in real time by synchronizing calculation with a real-time simulation mode, realizing simulations at different speeds by setting a super-real-time factor, and transmitting at least one of the operating parameters to a control-system interface for adjustment in a valve, the compressor, and the turbine in the flow network system.

2. The method according to claim 1, wherein a step of constructing the input card comprises:
designing a specific input card format allowing a user to input various parameters of the flow network system, comprising node sizes, pipeline connection relations, fluid physical property parameters, flow data, and external energy and momentum input; and
providing the input card in a form of a text file, with a method automatically reading and parsing input data;
wherein types of equipment available for input in the input card comprise a reactor, the turbine, the compressor, the heat exchanger, the valve, a pipeline, a temperature boundary, a pressure boundary, a flow boundary, a power boundary, and a single node.

3. The method according to claim 1, wherein a step of performing the node division on the flow network system comprises:
dividing models of the turbine and the compressor into the two nodes plus the one flow line, performing longitudinal node division on model of the heat exchanger in a multi-section manner, and adopting two heat component nodes for each longitudinal node; and
assigning an identification number to each node, storing identification numbers in flow lines, and generating the connection relation matrix with the identification numbers as coordinates and positions of the nodes in a node matrix as values to facilitate connection relation identification in subsequent flow network calculation.

4. The method according to claim 1, wherein the pressure drop of the turbine is calculated by a Stodola ellipse method.

5. The method according to claim 1, wherein relationships among a flow rate, a rotation speed and a pressure ratio of the compressor are obtained through characteristic curve calculation.

6. The method according to claim 1, wherein a two-dimensional matrix is constructed and solved for energy equations of two heat component nodes.

7. The method according to claim 1, wherein a step of constructing the pressure matrix and the enthalpy matrix of the flow network comprises:
calculating equipment parameters, linear terms and constant terms of an energy equation, and linear terms and constant terms of mass equation; and
gradually calculating a pressure change and an enthalpy change of each node in the flow network at a next time step through a semi-implicit difference format of a momentum equation.

8. The method according to claim 1, wherein the parallel algorithm solves the pressure matrix and the enthalpy matrix by a Gaussian elimination method with pivot selection, and steps comprise:
performing the pivot selection on a target matrix;
performing LU decomposition on the target matrix, and first calculating a first row of a U matrix and a first column of an L matrix in parallel;
calculating rows of the U matrix and columns of the L matrix corresponding to diagonal elements in parallel; and
calculating intermediate quantities of result variables, and finally calculating results.

9. The method according to claim 1, wherein the realizing simulations at the different speeds by setting the super-real-time factor comprises:
setting the super-real-time factor in the input card by a user, and accelerating a simulation process by a method according to a set multiple; and
synchronizing calculation with time of physical reality in the real-time simulation mode; and accelerating a calculation process by the method through increasing multiples in a super real-time simulation mode.
